(19) United States
(12) Patent Application Publication
(10) Pub. No.: US 2004/0022264 A1
(43) Pub. Date: Feb. 5, 2004

(54) Method of determining context in a subjectless message

(76) Inventor: Andrew Charles McCue, Oxford Mills (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/207,077

(22) Filed: Jul. 30, 2002

(51) Int. Cl. H04Q 7/20

(52) U.S. Cl. 370/464; 455/466

(57) ABSTRACT

A system and methods for transmitting and receiving text messages, in a messaging dialog with a recipient device, while maintaining the context of the messages without explicit mention of the context in the message is disclosed herein. In an embodiment of the invention, the system utilises a plurality of channels to determine the context of a received text message, based on a record of the channel and the context of a previous message.

### METHOD OF THE INVENTION

The present invention relates generally to digital wireless telecommunications. More particularly, the present invention relates to wireless messaging in a digital wireless telecommunications network.

### BACKGROUND OF THE INVENTION

In the field of digital wireless telecommunications, digital cellular telephones provide many services in addition to their basic telephony functionality. Because digital cellular telephones transmit voice signals as data packets additional data based services can be implemented using the same transmitter and receiver. Some of these services, such as encryption of transmitted data, are intrinsic to the standard operation of digital cellular telephones, while other services such as wireless e-mail delivery, or wireless web browsing are not fundamental to the provision of wireless telephone services.

Of these datacentric services, one of the most prevalent is the Short Message Service (SMS). SMS allows the transmission of short text messages to digital cellular handsets. Like other datacentric services, SMS is standardised to allow interoperability of numerous handset and network elements, and to facilitate the passing of SMS messages from one network to another. There is however, neither a guarantee of delivery, nor an ability to ensure in order delivery of messages.

SMS messages have three fields: an originating address, a destination address, and a message body. This allows SMS messages to be routed from a sending node to a receiving node without additional overhead. The routing of SMS messages is performed by an SMS message center. All SMS messages are relayed to an SMS messaging center, which then relays the message to either the recipient, or to an SMS messaging center in another network which in turn transmits the message to the recipient.

Included in standard SMS messaging center implementations is the ability to connect the messaging center to an SMS addressable computer system via a data connection. These data connections allow servers to be created for transmitting a large number of SMS messages over a high bandwidth connection to the SMS messaging center. Each of these data connections provide the SMS addressable computer with a unique SMS address to allow messages to be properly routed to and from the SMS addressable computer.

SMS addressable computer systems provide a number of services. One prominent service is provided by SMS addressable computers with a connection to the Internet which serve as SMS-to email gateways. These systems can transmit email messages to an SMS address, and allow SMS messages to be relayed to email addresses. Because all SMS messages used to transmit email messages are created by the SMS addressable computer they all bear the same originating address.

SMS addressable computers also serve as notification systems capable of transmitting an SMS message to a recipient when certain conditions are met. Such notification services provide stock price updates, inventory notifications, and alarm reminders.

Notification systems can be enhanced by providing the recipient of the notification the ability to reply to the notification with instructions based on the notification. For example in addition to transmitting a simple notification about a stock price, it is possible for the SMS addressable computer to inquire whether or not a selected stock should be purchased or sold at the present price. The notification of a change in stock price is used as the first message in a messaging dialog with the user of the recipient handset. The user receives the message and replies with instructions if a transaction is required. This bi-directional SMS messaging is referred to as a messaging dialog.

FIG. 1 illustrates a system for delivering a notification service. A dialog engine 100, the SMS addressable computer system of the previous example, has an SMS address of A0 and is connected to at least one data source 102. When data source 102 indicates that a monitored value has crossed a threshold, such as a stock falling below a given price, or inventory of a particular item falling below a determined count, dialog engine 100 transmits a message to a user to notify the user of the change in the tracked item. The user has a handset 106 having an SMS address of A1. The SMS notification message will have an originating address of A0, and a destination address of A1. SMS messaging center 104 receives the SMS notification message from dialog engine 100 due to the central position in the network topology that SMS messaging center 104 occupies. The SMS notification message is routed to handset 106 through wireless telephony network 112 in a path determined by SMS messaging center 104. Additional handsets, such as 108 and 110, each having a unique SMS address, exist in network 112, but do not receive messages destined for handset 106.

In the above example of a stock transaction the dialog has an understood context. Both the user and the dialog engine understand the context of the questions and replies. If a question about the number of shares to be purchased is transmitted, a response of ‘100’ is understood to mean that 100 shares should be purchased. Alternatively an inquiry about whether or not shares should be purchased can be replied to with a simple yes or no response without creating confusion. The dialog engine 100 is able to determine the context of a reply by recording the context of each notification and its destination address in a database. The information in the database can be used when an SMS reply notification is received to determine the context of the reply based upon the handset address, which appears in the originating address field of the SMS reply notification. This method of determining the context of a message fails when more than one notification has been transmitted to a handset before a reply is received. If, in the above example, a user requires a number of stocks to be monitored, it is conceivable that more than one notification will be issued before the user replies to the initial notification. Because there is more than one outstanding notification, the dialog engine 100 cannot determine the context of the reply.

To illustrate the difficult of discerning the context consider the following scenario. Dialog engine 100 transmits the following four questions, all of which can be replied to with ‘yes’ or ‘no’ replies, “Do you like cheese?”; “Do you have a criminal record?”; “Do you want to buy 100 shares of stock A at market price?”; and “Do you want to sell 100 shares of stock B at market price?”. So long as the user replies to each question prior to the transmission of the next, dialog engine 100 can easily determine the context of the reply. If all of the notifications are transmitted in series, and no reply is received between the transmission of the notifications, the context of a reply cannot be determined. Because SMS messaging provides neither a guarantee of delivery, nor a guarantee of in order delivery, simple first in first out, or last in first out, queuing cannot be reliably used.

Queuing of messages, until a first dialog has been completed, can provide dialog engine 100 with context for each reply, but queuing assumes that a user will reply promptly to each message and that the queued messages do not become irrelevant while queued which may happen with time sensitive transaction notifications.

Without a means to determine the context of a reply, notification systems are incapable of engaging in time sensitive dialogs. To overcome this problem dialog engines have been designed that introduce context to replies by inserting an ID tag into the body of the SMS notification message. This ID tag, and an associated context, is stored in a database prior to transmitting the SMS notification message. Upon receiving a reply, the dialog engine can determine the context of the reply by performing a database query on an ID tag retrieved from the body of the SMS reply message. Dialog engine 100 retrieves the ID tag from the body of the message by parsing the message which must be structured in a predefined format. An SMS notification using ID tags is shown in FIG. 2. The SMS notification message 114 of FIG. 2 consists of both originating and destination SMS addresses 120 and 122 respectively, as well as a body field 118. The notification text and ID tag 116 are both in body field 118. This message is created by dialog engine 100 in response to conditions in data sources 102. Dialog engine 100 stores the context of notification 114 along with ID tag 116 in a database, so that the context of a reply can be determined based on the retrieved tag. The stored context is typically represented by an alphanumeric code used to identify a transaction, though particular implementations will vary as will be understood by one of skill in the art.

In this example the recipient of notification 114, responds by transmitting SMS reply message 124, which is illustrated in FIG. 3. SMS reply message 124 is transmitted by handset 106 having address Al to dialog engine AO, thus the originating and destination addresses 120 and 122 of SMS reply message 124 are the opposite of those in SMS notification message 114. The body 130 of SMS reply message 124 must contain ID tag 116 so that dialog engine 100 can parse body 130 to determine the context of the SMS reply message 124. ID tag 116 must either be manually entered into the body of SMS reply message 124 by the user, or if the feature is provided by the handset, the user can copy the text of the SMS notification message 114 into body 130 and then proceed to edit the copied text to leave ID tag 116 in place.

Upon receiving SMS reply message 124, dialog engine 100 can determine the context of the reply by parsing body 130 for ID tag 116. To ensure that dialog engine 100 can properly parse body 130, body 130 must be rigidly structured. This structure can vary from one implementation to another, but it typically requires that ID tag 116 either appear in a consistent location in the message, or requires that a predefined prefix and suffix surround ID tag 116. In one example the prefix and suffix may be open and closed square brackets that set ID tag 116 off from the rest of body 130. Upon extracting ID tag 116 from reply 124, dialog engine 100 performs a lookup in its database to determine the context of reply 124 based on ID tag 116. Using this method of tagging each SMS notification message 114 with ID tag 116, multiple SMS notifications messages can be generated and transmitted to a user, and the context of each message can be uniquely associated with the unique ID tag assigned to each notification. By placing the unique ID tags into the SMS reply messages the user can ensure that dialog engine 100 can determine the context of the reply with a simple database query.

Though ID tag 116 provides a solution for determining the context of the message, it is far from ideal. The insertion of ID tag 116 requires the user to enter ID tag 116 in the body of the SMS reply message. The insertion of ID tag 116 requires either use of a handset to copy the text of notification 114 into body 130 and then manual editing of body 130 to remove extraneous information, or it requires manual entry of ID tag 116 by the user. Manual entry of ID tag 116 is prone to user error and may require the user to write ID tag 116 on a piece of paper to ensure that it is transposed properly. An additional restriction imposed by use of an ID tag, is that a fixed format, as described above, must be used, so that ID tag 116 is not confused with the reply to the notification. Use of a rigid format for SMS reply message 124 requires a level of user sophistication that cannot be guaranteed in a general population. An additional disadvantage of the system, is that a user can inadvertently enter the wrong ID tag , and thus inadvertently supply an answer to a different notification, which is clearly undesirable.

It is, therefore, desirable to provide a method and system for determining the context of a reply to a notification without requiring an ID tag in the reply message.

### SUMMARY OF THE INVENTION

It is an object of the present invention to obviate or mitigate at least one disadvantage of previous methods and systems for determining the context of a reply. It is a further object of the present invention to provide a method and system for determining the context of a reply message, based on the channel through which the message is received.

In a first aspect, the present invention provides a method of transmitting a text message, from a dialog engine to a recipient device, in a messaging dialog, over one of a plurality of unique channels, to preserve the context of the messaging dialog. The method of the first aspect comprises the steps of generating the text message, selecting one of the plurality of channels, transmitting the generated text message to the receiving device over the selected channel, and associating the selected channel and the context of the text message. In an embodiment of the first aspect, the plurality of channels includes of a plurality of logical channels. In another embodiment of the present invention the step of associating the selected channel and context is done by associating the channel and context with each other in a database. In a further embodiment of the first aspect, the text message has no subject field, and each channel in the plurality is defined by unique originating and destination addresses. In yet another embodiment, the step of selecting includes examining the associated channel information to find a channel not previously used.

In a second aspect of the present invention there is provided a method of determining the context of a text message in a messaging dialog, where the text message is received from a transmitting device, through one of a plurality of unique channels by a dialog engine having a record of associated unique channel and context pairings. The method of the second aspect comprises the steps of receiving the transmitted text message, identifying the channel through which the received text message was transmitted, and determining the context of the received text message, based on the record of associated unique receiving channel and context pairing. In an embodiment of the present invention, there is provided a further step of removing, from the record, **the channel and context pairing that corresponds to the received message. In another embodiment of the present invention, the channels through which the dialog engine receives text messages are logical channels. In a further embodiment, the channel that a text message is received over is identified by originating and destination addresses associated with the text message. In another embodiment, the step of determining the context of the received text message includes referencing a database using the identified channel as an index.

In a third aspect of the present invention, there is provided a dialog engine, for transmitting and receiving text messages, in a messaging dialog, to and from recipient devices via a messaging center. The dialog engine also receives information from a data source, and both associates and determines the context of the received text messages. The dialog engine comprises a plurality of text messaging channels to the messaging center, a text message generator, a channel selector, a transmitter, a receiver, and a channel and context database. The text message generator is for generating text messages for recipient devices, based on information received from the data source. The channel selector is for selecting a text messaging channel to transmit the generated text message over. The transmitter is for transmitting the generated text message to the recipient device over the selected channel. The receiver is for receiving a text message from the recipient device over one of the plurality of text messaging channels. The channel and context database is for recording the association of channel and context information for transmitted messages, and for determining the context of received text messages from the receiving text messaging channel and the recorded context and channel associations. In an embodiment of the third aspect of the present invention, the text messages are short message service messages. In a further embodiment of the present invention, the plurality of text messaging channels is provided by logically dividing a single text messaging channel. In an alternate embodiment, the plurality of text messaging channels is provided by establishing a plurality of unique physical channels, which, in a further embodiment, is provided by a plurality of SMS modems.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a network schematic of a prior art system for transmission of SMS notification messages;

FIG. 2 is an illustration of the format of a prior art notification using an ID tag;

FIG. 3 is an illustration of the format of a prior art reply using an ID tag;

FIG. 4 is a network schematic of an embodiment of the system of the present invention;

FIG. 5 is a network schematic of an embodiment of the system of the present invention;

FIG. 6 is a flowchart illustrating a method of transmitting a notification according to an embodiment of the present invention; and

FIG. 7 is an illustration of the format of a notification of the present invention;

FIG. 8 is an illustration of the format of a reply of the present invention; and

FIG. 9 is a flowchart illustrating a method of receiving a reply according to an embodiment of the present invention.

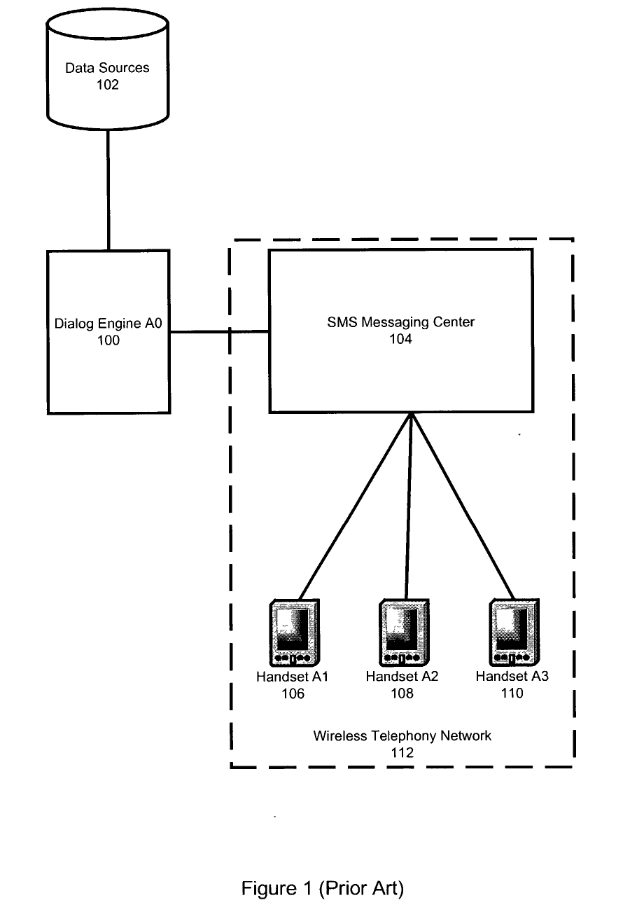

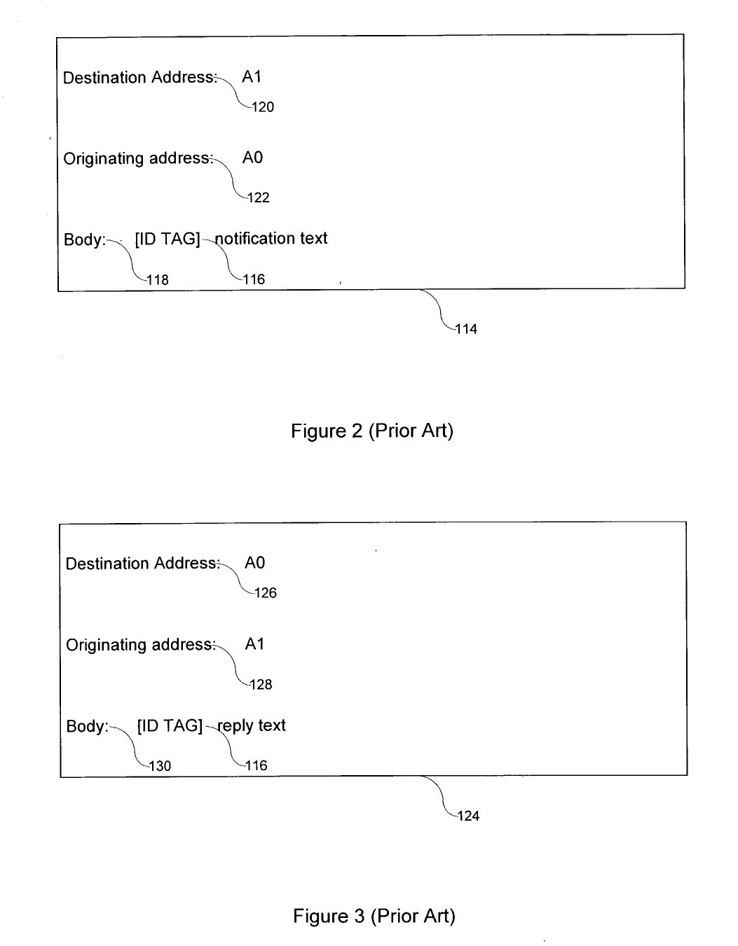

### DETAILED DESCRIPTION

Generally, the present invention provides a method and system for determining the context of a messaging dialog that consists of text messages that do not have a subject field. The provided method and system derive the context of a dialog without inserting ID tags into the body of the message.

The present invention will be described with relation to the transmission of SMS messages, though one of skill in the art will readily appreciate that the methods and system of the present invention are appropriate for the transmission of all manners of text messages, and are particularly appropriate for the transmission of text messages without subject fields.

All SMS addressable devices, including both handsets and SMS addressable computers, are provided with unique SMS addresses. These addresses provide both identification and routing information. A unique logical channel can be defined between any two SMS addressable devices using the SMS addresses of the two devices as an identifier for the channel.

By providing dialog engine 100 with a plurality of unique SMS addresses, a plurality of channels between dialog engine 100 and a recipient handset, such as handset 106, are created. When dialog engine 100 transmits an SMS notification message to handset 106 using one of a plurality of the aforementioned channels, it can record the channel identification information with the context of the SMS notification message in a database. When replying to an SMS notification message, a user automatically transmits an SMS reply message to dialog engine 100 using the same channel that was used to transmit the SMS notification message. Upon receiving a reply over the same channel used to transmit the SMS notification message, the channel information, which is determined using the source address in the SMS header and the address to which the message was delivered (the receiving device), can be used to reference the database to determine the context of the reply. If, prior to receiving an SMS reply message associated with the first SMS notification message , a second SMS notification message is transmitted, a second of the plurality of channels can be used, and recorded in the database to associate the context of the second SMS notification message with the channel. From the perspective of the user, handset 106 will receive notifications from a variety of SMS addresses. Instead of replying to a single address and inserting an ID tag, simply replying to the notification will transmit an SMS reply to the address that transmitted the notification. Because the context of the SMS notification is associated with the channel used to transmit the notification, simply receiving an SMS reply on a channel provides dialog engine 100 with sufficient information is to determine the context of the reply.

The association of one of a plurality of channels with the context of a message obviates the need for an ID tag. If a sufficient number of channels are available, no queuing of messages is required. Each channel is identified by the originating address in the SMS message and the destination address at which the message arrived, such as dialog engine 100. A simple database query, akin to a query based on an ID tag, will provide dialog engine 100 with the context of the reply without requiring the insertion of a tag by the user.

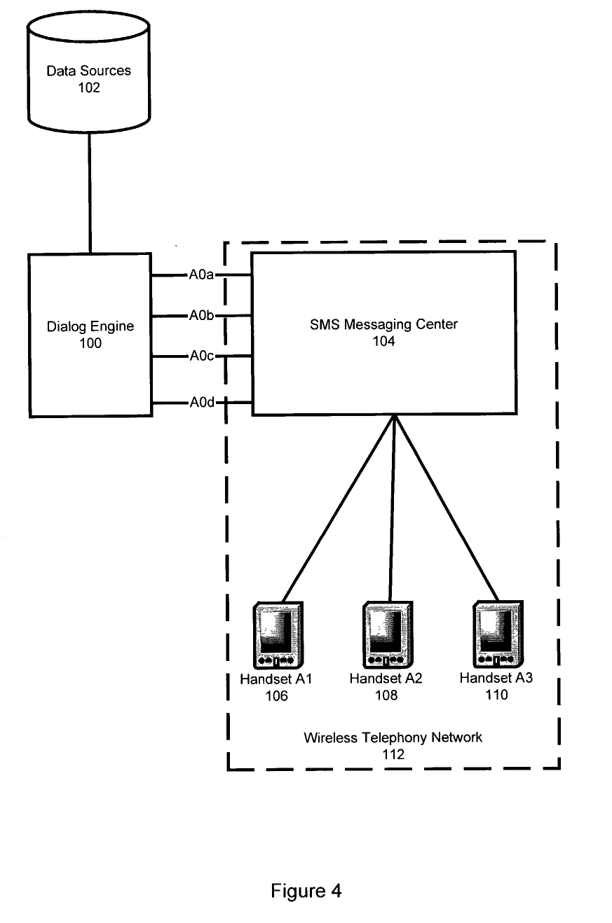

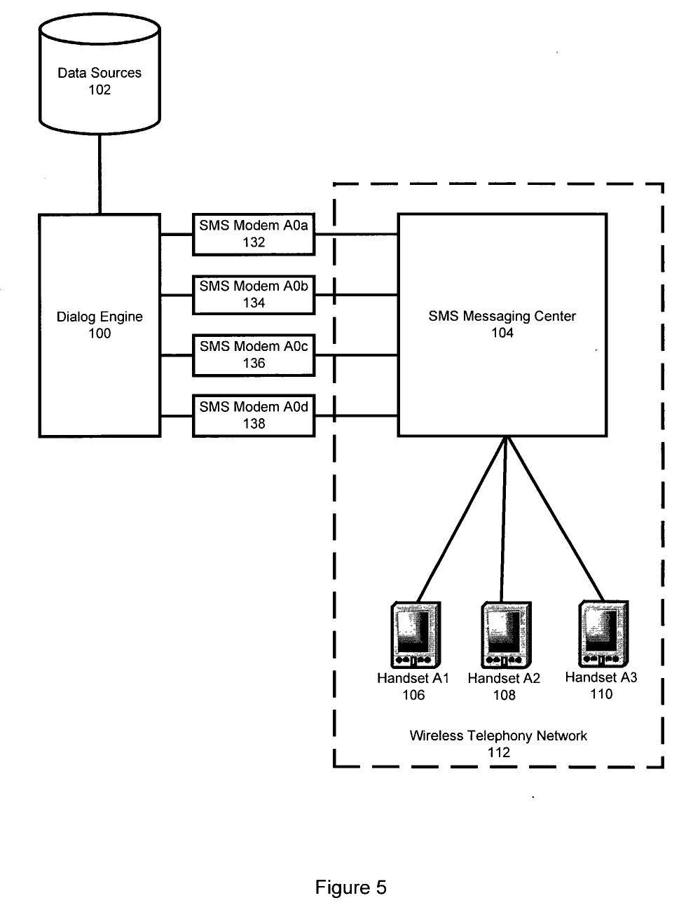

An exemplary system is illustrated in FIG. 4. The dialog engine 100, is connected to data sources 102. Dialog engine 100 determines that a notification should be generated on the basis of the state of data sources 102. Dialog engine 100 generates SMS notification messages and transmits them to a plurality of handsets 106, 108 and 110. The notifications are transmitted to the plurality of handsets via SMS messaging center 104. Dialog engine 100 communicates with SMS messaging center 104 over a plurality of connections, which are each assigned a unique SMS address. The connections between the SMS messaging center 104 and the dialog engine 100, are identified as A0a, A0b, A0c and A0d. Prior to transmitting a notification, dialog engine 100 selects the connection to the SMS message center 104 that will be used to transmit the generated notification, as will be described below. The SMS messaging center 104 is connected to handsets 106, 108 and 110 within wireless telephony network 112.

The connections, A0a, A0b, A0c and A0d, can be either logical or physical connections. Logical connections can be created by assigning dialog engine 100 with a plurality of unique SMS addresses and one physical connection. When SMS notificaiton messages are transmitted to SMS messaging center 104, dialog engine 100 specifies which of the assigned SMS addresses the notification message originated from. Upon receiving an SMS reply message addressed to one of the plurality of SMS addresses assigned to dialog engine 100, SMS messaging center 104 transmits the reply message to dialog engine 100. By providing only one physical connection to SMS messaging center 104 with a plurality of SMS addresses a plurality of logical channels are created. Dialog engine 100 can connect to SMS messaging center 104 with one or more high bandwidth connection and still benefit from the present invention.

FIG. 5 illustrates an alternate embodiment, where connections A0a, A0b, A0c and A0d are provided using distinct physical channels. Dialog engine 100 is multiply connected to SMS messaging center 104 by a plurality of SMS modems 132, 134, 136 and 138 respectively. Each SMS modem in this embodiment is assigned a single SMS address. One of skill in the art will readily appreciate that the number of physical connections can be varied without departing from the scope of the present invention.

Handsets 106, 108 and 110 need not necessarily be digital cellular telephones. Instead any recipient device, having a unique SMS address, capable of receiving and transmitting text messages can be substituted without departing from the scope of the present invention.

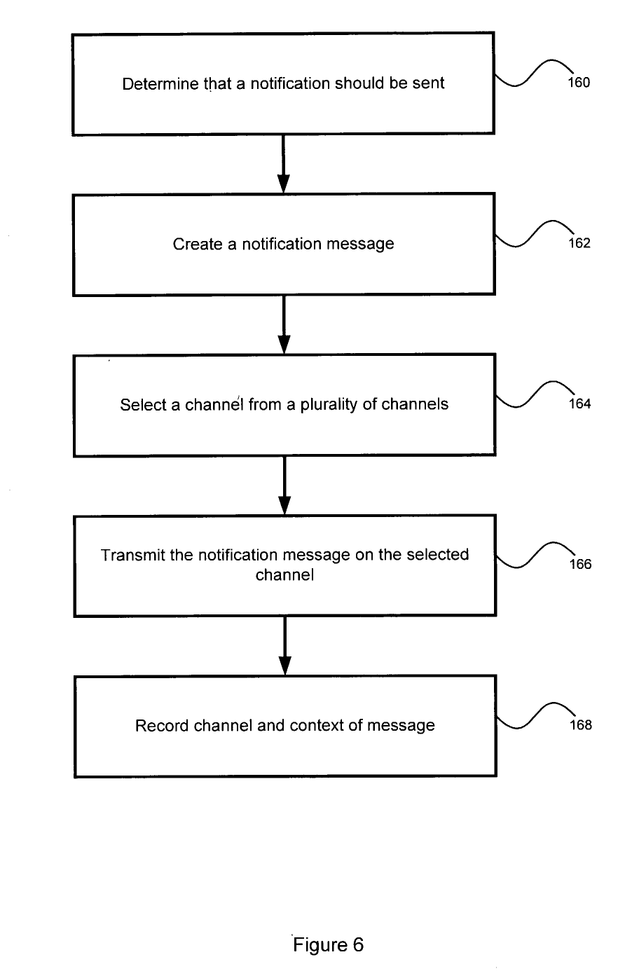

FIG. 6 provides a flowchart that illustrates the steps of a method of transmitting a notification according to an embodiment of the present invention. Based on the state of data sources 102, dialog engine 100 determines that an SMS notification message should be generated in step 160. The context of SMS notification message, and its destination are also determined by the state of data sources 102. In step 164, the originating address of the SMS notification message is selected from the plurality of originating addresses assigned to dialog engine 100. This selection of the originating address determines the logical channel that will be used to transmit the SMS notification message. A logical channel is available for selection by dialog engine 100 if it has not been used to transmit a prior SMS notification message for which a reply has not been received. If a logical channel has been used for a prior SMS notification message for which a reply has not been received a different logical channel is selected. This allows the context of the notification to be uniquely associated with the logical channel information. In step 166 the addressed SMS notification message is transmitted over the selected channel to the handset via SMS messaging center 104. Following the transmission of the notification by dialog engine 100, the notification is routed to the intended recipient, such as handset 106, by SMS messaging center 104. The channel used to transmit the message, and the context of the message are recorded by dialog engine 100 in a database. In contrast with previous methods, no code, or other identifier, is inserted into the body of the SMS message.

To allow for the case where an SMS notification message is not replied to, the logical channel associated with the context of the notification can be cleared if no reply is received within a predetermined timeout period. The use of a timeout period prevents dialog engine 100 from not being able to transmit messages to a recipient if no replies are received. The timeout value can be chosen based on estimated traffic and the number of available channels to prevent dialog engine 100 from having to queue SMS notifications for delivery to a user.

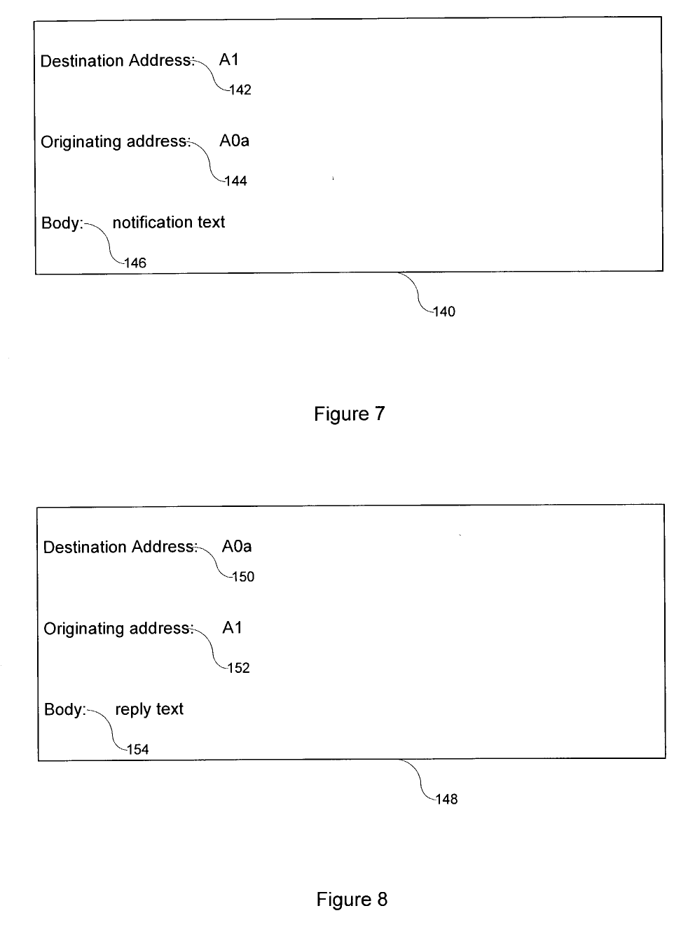

A sample notification message 140 is illustrated in FIG. 7. The destination address field 142 contains the address of the handset to which the message is being transmitted, while the originating address field 144 includes the address of the connection between dialog engine 100 and SMS messaging center 104. The body 146 of the message only contains the notification text, as the unique channel is used to determine the context of the associated reply.

An SMS reply message 148 is illustrated in FIG. 8. The SMS reply message is typically created by selecting a reply function on the receiving handset. Alternatively the reply message can be manually created by the user. To manually create the SMS reply message the user enters the sending address used by the dialog engine 100 that was used to transmit the associated SMS notification message as a destination address 150, and provides a response to the notification message in the body 154 of the reply. The destination address 150 and the originating address 152 in the SMS reply message correspond with the address used dialog engine 100 to transmit the reply and the address of handset 106. These addresses are the reverse of the addresses of the SMS notification message because the reply message is going in the opposite direction. The body field 154 of SMS reply message 148 contains the reply to the notification message.

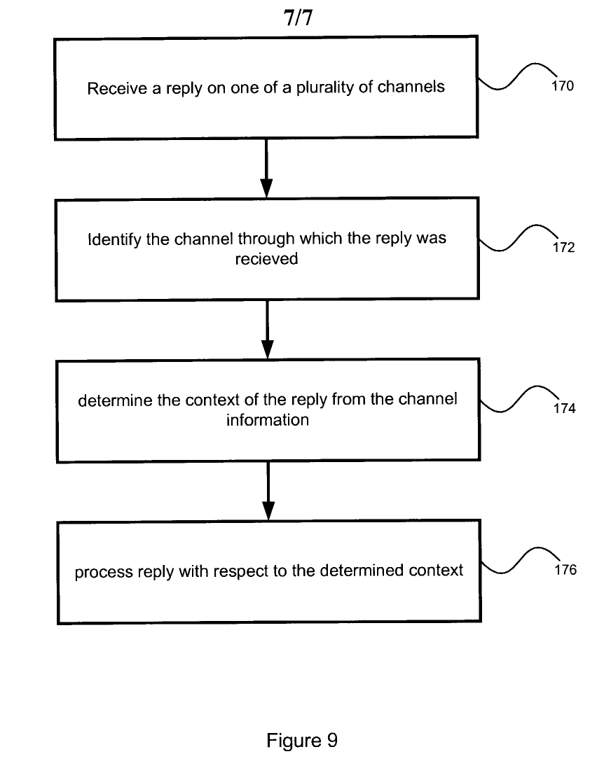

Upon receiving an SMS reply message, dialog engine 100 follows the method of FIG. 9 to determine the context of the reply 148.

In step 170, dialog engine 100 receives an SMS reply message over one of the plurality of connections to SMS messaging center 104. Based on the originating address field 152 and the address of the receiving device 150 of the received SMS reply message the channel through which the reply was transmitted is identified in step 172. Because a channel is reused only either after receipt of a reply to an outstanding notification or after a timeout has occurred on a previously outstanding notification, the channel is uniquely associated with the context of the last SMS notification message that was transmitted over it. Based on the channel over which the SMS reply message 148 is received, the context of the reply is determined in step 174. In a presently preferred embodiment, this determination is performed by querying a database in which the channel used to transmit the associated notification and the context of the associated notification at step 168. This provides dialog engine 100 with the context of the SMS reply message, thus permitting dialog engine 100 to associate the reply with its respective notification in step 176.

The step of selecting a channel 164 allows the selection of different channels for different dialogs. Thus a channel used for a first dialog can be reserved from further use until its further use is non-ambiguous. Typically, ambiguity is avoided by reusing a channel only when a reply is received or when a time limit expires.

To provide further explanation of the system and methods of the present invention an exemplary scenario is provided. This scenario is for the purposes of illustration and should not be considered limiting the scope of the invention or its applications. Assume that data sources 102 contain, among other information, both inventory levels of various products and sales figures. When the quantities of different products are reduced to below predetermined levels a purchasing manager is informed on handset 106 having address Al by dialog engine 100. At fixed intervals during the day different sales people are contacted by dialog engine 100 to determine their sales of various items.

At a fixed time, dialog engine 100 contacts a first salesperson at handset 108 having address A2. The dialog engine 100 selects connection A0a to transmit the notification. The notification has the format of notification 140, with the originating address of A0a, and a destination address of A2. The body of the notification inquires how many units of a first product have been sold. Upon sending the notification, dialog engine 100 records the channel and context information. Recording the context of the notification allows the context of the reply to be discerned from the channel information. A second notification is transmitted a few minutes later with an originating address of A0b and a destination of A2, asking how many units of a second product have been sold. The originating address A0b was chosen as there is an SMS reply message expected on A0a. The selection of an unused channel avoids ambiguity. Once again, the channel and context information of the second notification message are stored. The salesperson responds to the second inquiry, simply by replying to the message with a number. The reply to the second inquiry is received by dialog engine 100 over a channel defined by the addresses A0b and A2. From this information, dialog engine 100 is able to query its database to determine the context of the reply. The database query will indicate which question was asked. This allows dialog engine 100 to update the inventory information for the second product by decrementing the inventory by the number sold.

After being updated, data source 102 indicates that the inventory of the second product has dropped to a level at which a re supply order should be placed. Dialog engine 100 creates a notification for the purchasing manager, and selects a channel over which to transmit the notification. Because there are no outstanding alerts to the destination address A1, corresponding to the purchasing manager, the originating address A0a can be used. The channel defined between A0a and A1 defines a non-ambiguous context. A notification to handset 106 having address A1 can be transmitted from dialog engine 100 requesting instructions to increase the inventory of the second product. The purchasing manager can then either reply to the notification and instruct an automated reorder, or can re-order the supplies and reply that the supplies have been ordered. Either of such replies is received by dialog engine 100 over connection A0a. The SMS reply message contains an originating address of A1, and arrives via A0a. These two address can be used by dialog engine 100 to discern first that it is the purchasing manager that is providing a reply, and secondly the context of the reply. The context of the reply is determined by querying the database to determine the context that uniquely corresponds to the channel over which the reply was received. The outstanding notification to the salesperson can then be either responded to, or if a reply is not received within a predetermined period of time, the notification can expire, and the channel is cleared for future use. In one embodiment of the present invention, prior to the clearing of the channel for future use a notification is transmitted to handset 108 using the channel on which a reply is expected to report that a timeout has occurred, and that the previous notification transmitted on the channel has expired. This notification message is transmitted to ensure that the user is aware that no reply is expected to the outstanding notification.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of transmitting a text message, from a dialog engine to a recipient device, in a messaging dialog, over one of a plurality of unique channels, to preserve the context of the messaging dialog, the method comprising:
generating the text message;
selecting one of the plurality of channels for transmitting the generated text message to the receiving device over the selected channel; and
associating the selected channel and the context of the text message.

2. The method of claim 1, wherein the plurality of channels are logical.

3. The method of claim 1, wherein the selected channel and the context of the text message are associated with each other in a database.

4. The method of claim 1, wherein the text message has no subject field.

5. The method of claim 1, wherein the plurality of channels are each defined by unique originating and destination addresses.

6. The method of claim 1, wherein the step of selecting includes examining the associated channel information to find a channel not previously used.

7. A method of determining the context of a text message in a messaging dialog, the text message received from a transmitting device, through one of a plurality of unique channels by a dialog engine having a record of associated unique channel and context pairings, the method comprising:
receiving the transmitted text message;
identifying the channel through which the received text message was transmitted; and
determining the context of the received text message based on the record of associated unique receiving channel and context pairing.

8. The method of claim 7, further including the step of removing, from the record, the channel and context pairing corresponding to the received message following the step of determining the context of the received text message.

9. The method of claim 7, wherein the channels are logical.

10. The method of claim 7, wherein the channel is identified by the originating and destination addresses.

11. The method of claim 7, wherein the step of determining the context includes referencing a database using the identified channel as an index.

12. A dialog engine, for transmitting and receiving text messages, in a messaging dialog, to and from recipient devices via a messaging center, for receiving information from a data source, and for associating and determining the context of the received text messages, the dialog engine comprising:
a plurality of text messaging channels to the messaging center;
a text message generator, for generating text messages for recipient devices, based on information received from the data source;
a channel selector for selecting a text messaging channel to transmit the generated text message over;
a transmitter for transmitting the generated text message to the recipient device over the selected channel;
a receiver for receiving a text message from the recipient device over one of the plurality of text messaging channels; and
a channel and context database, for recording the association of channel and context information for transmitted messages, and for determining the context of received text messages from the receiving text messaging channel and the recorded context and channel associations.

13. The dialog engine of claim 12, wherein the text messages are short message service messages.

14. The dialog engine of claim 12, wherein the plurality of text messaging channels is provided by logically dividing a single text messaging channel.

15. The dialog engine of claim 12, wherein the plurality of text messaging channels is provided by establishing a plurality of unique physical channels.

16. The dialog engine of claim 15, wherein the plurality of unique physical channels is provided by a plurality of SMS modems.
